(19) United States
(12) Patent Application Publication
(10) Pub. No.: US 2026/0029102 A1
(43) Pub. Date: Jan. 29, 2026

(54) LIGHTING DEVICE FOR THE REAR END OF A MOTOR VEHICLE

(71) Applicant: HELLA GMBH & CO. KGAA, Lippstadt (DE)

(72) Inventor: Kai Polenz, Geseke (DE)

(21) Appl. No.: 19/348,905

(22) Filed: Oct. 3, 2025

Related U.S. Application Data
(63) Continuation of application No. PCT/EP2024/053042, filed on Feb. 7, 2024.

(30) Foreign Application Priority Data
Apr. 3, 2023 (DE) 102023108414.3
May 26, 2023 (DE) 102023113946.0

(51) Int. Cl. F21S 43/33; F21S 43/14; F21S 43/31; F21W 103/10; F21W 103/35

(52) U.S. Cl. CPC F21S 43/332; F21S 43/14; F21S 43/31; F21W 2103/10; F21W 2103/35

(57) ABSTRACT

A lighting device for a motor vehicle is provided. The lighting device includes: a first light source and a second light source; a housing on or in which the first light source and the second light source are arranged; and a first exit surface for light emitted by the first light source and a second exit surface for light emitted by the second light source. In the installed state, light generated by the first light source emits at least partially downwards from the housing through the first exit surface, and light generated by the second light source emits at least partially rearwards from the housing through the second exit surface. The lighting device further includes a reflection device outside of the housing. Light emitted downwards through the first exit surface strikes the reflection device and is reflected by the reflection device so that it moves rearwards from the motor vehicle.

### CROSS-REFERENCE TO RELATED APPLICATIONS

The present application is a continuation of PCT/EP2024/053042, filed Feb. 7, 2024, which claims priority to German Patent Application DE 10-2023-108-414.3, filed Apr. 3, 2023, and German Patent Application DE 10-2023-113-946.0, filed May 26, 2023, the disclosures of which are incorporated by reference in their entirety.

### FIELD OF THE INVENTION

The present invention relates to a lighting device for the rear end of a motor vehicle.

### BACKGROUND OF THE INVENTION

Lighting devices arranged in the rear end of a motor vehicle are well known. They can be used to generate different lighting functions and can, for example, function as a tail light, a brake light, a position light, a reversing light, a daytime running light or a direction indicator. The light generating these lighting functions is usually emitted directly from the lighting device rearward.

A lighting device of the type mentioned at the beginning is known from KR 1020230000848A1. The lighting device described therein comprises a housing with a first and a second light source and with a first and a second exit surface. The lighting device is arranged so that the light emitted by the first light source exits the housing downwards through the first exit surface to generate license plate lighting and the light generated by the second light source exits the housing rearwards through the second exit surface to generate a tail light.

### SUMMARY OF THE INVENTION

The problem underlying the present invention is the creation of a lighting device of the type mentioned above, which has a design that differs from the taillights described and makes it possible to achieve an appealing external impression.

According to the invention, this is achieved by a lighting device as described herein. According one embodiment, it is provided that the lighting device comprises a reflection device disposed outside of the housing, and that the lighting device is arranged such that the light emitted downwards through the at least one first exit surface at least partially strikes on the reflection device and is at least partially reflected by the reflection device such that it moves away from the rear end of the motor vehicle rearward. In particular, the lighting device can be set up so that the light emitted by the first light source is used to generate a tail light and/or that the light emitted by the at least one second light source is used to generate a brake light. This design ensures that the light intended for generating a taillight does not emerge directly from the rear of the lighting device, but is reflected backwards from an area underneath part of the housing.

It may be provided that the reflection device has a diffusing structure. The diffusing structure allows the light to be at least partially reflected back diffusely.

It is possible for the reflection device to have a transparent component that has an entry surface for the light emitted through the cover panel. By integrating a transparent component into the reflection device, an impression can be created for the observer that makes it unclear about the exact position of the plane of the reflection. Such reflection devices are sometimes also called “frosted glass”.

It may be provided that the reflection device has a reflective layer that at least partially reflects the incident light. Alternatively, the reflection device may have a component, in particular an opaque component, which at least partially reflects the incident light.

It is possible for the diffusing structure to be arranged on the entry surface of the transparent component or on an exit surface of the transparent component opposite the entry surface.

It may be provided that the reflective layer or the component, in particular an opaque component, is arranged on the exit surface of the transparent component opposite the entry surface. In particular, this type of design gives the impression when looking at the reflection device that the exact position of the plane of the reflection cannot be detected.

It is possible for the diffusing structure to be arranged on the exit surface of the transparent component opposite the entry surface and for the reflective layer or the component, in particular the opaque component, to be arranged on the side of the diffusing structure of the transparent component facing away from the exit surface.

Alternatively, the reflective layer can also be arranged in the transparent component.

It may be provided that the lighting device comprises a first reflector arranged in the housing, wherein the lighting device is arranged so that the light generated by the first light source is at least partially reflected by the first reflector onto the first exit surface so that it can at least partially emerge therefrom, in particular wherein the first reflector is concavely curved. The inclination and, if necessary, the curvature of the reflector can be used to determine where and how the light strikes the reflection device. For example, the light can have a greater intensity in an upper part of the reflection device than in a lower part of the reflection device. It may also be provided that the reflector has several reflective surfaces, preferably inclined to each another, which are arranged in such a way that at least parts of the light generated by the light source are reflected several times by the reflector before it strikes the first exit surface. This can result in better homogenization of the light emerging through the first exit surface. Furthermore, a greater proportion of the light emitted by the light source can be reflected to the first exit surface by the plurality of reflective surfaces. This improves the performance of the lighting device.

It is possible that the lighting device comprises at least one second reflector arranged in the housing, wherein the lighting device is arranged so that the light generated by the at least one second light source is at least partially reflected by the at least one second reflector onto the second exit surface so that it can at least partially emerge therefrom, in particular wherein the at least one second reflector is concavely curved. The lighting device can have two second light sources, two second reflectors and two second exit surfaces, which are designed to be arranged in a lateral edge area of the rear of the motor vehicle when the lighting device is installed. Due to this design, a brake light can be realized using the second light sources, the second reflectors and the second exit surfaces.

It may be provided that the reflection device is arranged to extend over the entire or almost the entire width of the motor vehicle when the lighting device is installed. This measure also makes it possible to achieve an attractive design for the lighting device.

It is possible that the lighting device comprises at least one cover panel which covers the housing at least partially, in particular with the first exit surface and the second exit surface being formed in the at least one cover panel.

It may be provided that the reflection device is arranged on the outside of the housing and/or on the outside of the at least one cover panel, wherein the reflection device is arranged on a section of the housing and/or of the cover panel which extends downwards below the first exit surface when the lighting device is installed, in particular wherein the section extending downwards forms an angle of between 30° and 80° with the first exit surface.

### BRIEF DESCRIPTION OF THE DRAWINGS

The invention is explained in more detail below with reference to the attached drawings. In the figures:

FIG. 1 is a schematic sectional view through a central section of an embodiment of a lighting device according to the invention;

FIG. 2 is a schematic sectional view through an edge section of an embodiment of a lighting device according to the invention;

FIG. 3 is a schematic sectional view of a first embodiment of a reflection device of a lighting device according to the invention;

FIG. 4 is a schematic sectional view of a second embodiment of a reflection device of a lighting device according to the invention;

FIG. 5 is a schematic sectional view of a third embodiment of a reflection device of a lighting device according to the invention; and

FIG. 6 is a schematic sectional view of a fourth embodiment of a reflection device of a lighting device according to the invention.

### DETAILED DESCRIPTION OF THE CURRENT EMBODIMENT

In the figures, identical or functionally identical parts are marked with the same reference symbols.

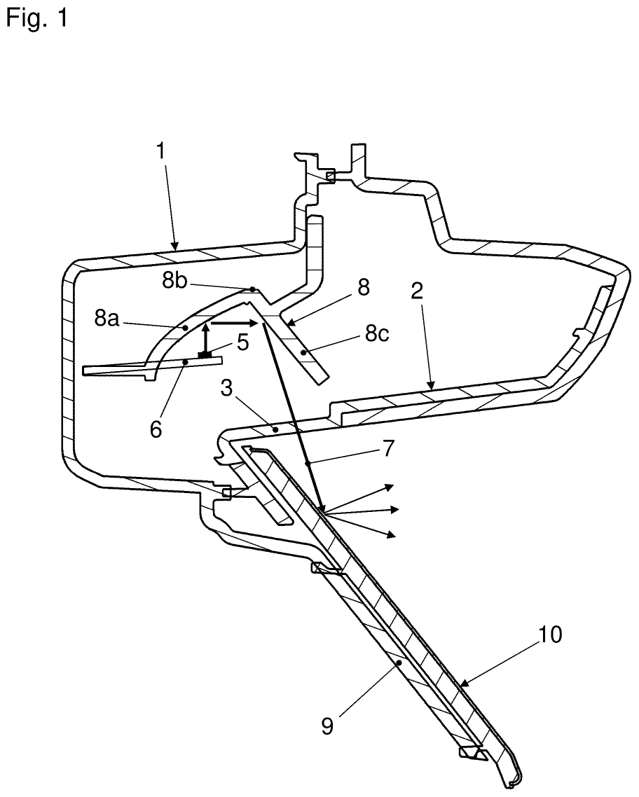

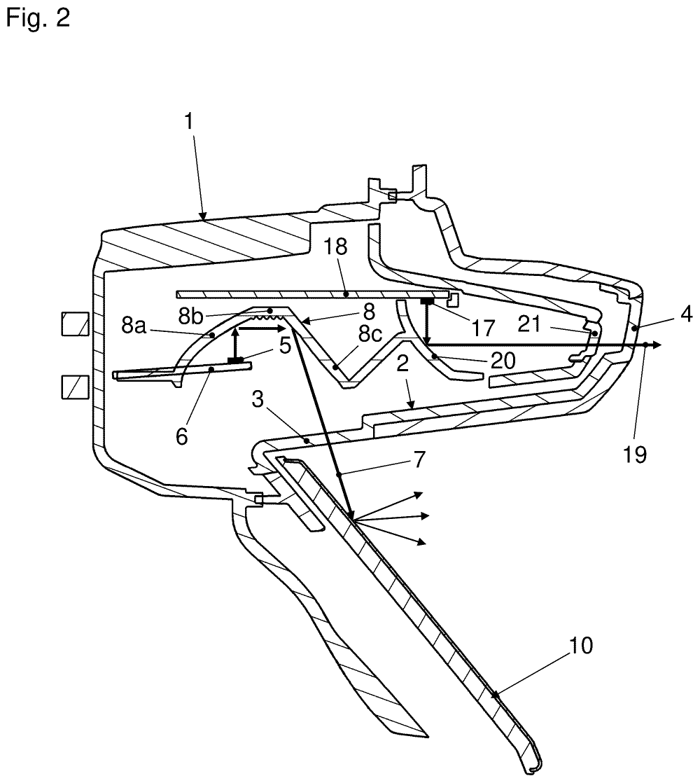

The lighting device shown in the figures is designed in particular as a combination tail light and extends over the entire or almost the entire width of the motor vehicle. FIG. 1 shows a section through a central section of the lighting device extending across the width of the motor vehicle with respect to the transverse direction of the motor vehicle, whereas FIG. 2 shows a section through an outer area of the lighting device with respect to the transverse direction of the motor vehicle.

The lighting device comprises a housing 1 and a cover panel 2, which covers the housing 1 at least partially. The cover panel 2 is at least partially transparent. It has a first exit surface 3 on the underside of the housing 1 (see FIGS. 1 and 2) and two second exit surfaces 4 on the rear side of the housing 1 (see FIG. 2).

The housing 1 and the cover panel 2 extend into the drawing plane of FIGS. 1 and 2 or in the transverse direction of the motor vehicle when the lighting device is installed. Both the shape of the housing 1 and the shape of the cover 2 change in the transverse direction of the motor vehicle. FIGS. 1 and 2 show that only the first exit surface 3 is provided in the central section with respect to the transverse direction of the motor vehicle, whereas one of the second exit surfaces 4 is provided in addition to the first exit surface 3 in the outer areas with respect to the transverse direction of the motor vehicle. The two outer areas with regard to the transverse direction of the motor vehicle have the same design and correspond to the section shown in FIG. 2.

The lighting device further comprises a first light source 5, which has one, preferably several, light-emitting diodes (LEDs) arranged on a printed circuit board 6. The light-emitting diodes of the first light source 5 can be arranged next to each other, particularly in the transverse direction of the motor vehicle. The printed circuit board 6 is arranged horizontally in the housing 1 so that the light 7 emitted by the first light source 5 spreads upwards within the housing 1 in FIGS. 1 and 2 or in the installed state from the first light source 5.

The light-emitting diodes of the first light source 5 can also have different colors in order to implement different functions such as a tail light, a brake light, a position light, a reversing light, a daytime running light or a direction indicator. In the embodiment example shown, the light 7 emitted by the first light source 5 is used to generate a tail light.

The lighting device further comprises a first reflector 8, which is arranged in the housing 1 such that the light 7 emitted by the first light source 5 is at least partially reflected downwards by the first reflector 8 in the direction of the first exit surface 3 and emerges at least partially downwards from the housing 1 through this. In particular, the first reflector 8 can be partially or sectionally concavely curved.

The first reflector 8 of the embodiment shown has three reflective surfaces 8a, 8b, 8c that are inclined towards each other. The first reflective surface 8a extends upwards from the printed circuit board 6, the second reflective surface 8b adjoins the first surface 8a and extends horizontally to the right in FIGS. 1 and 2. The third reflective surface 8c adjoins the second surface 8b.

In this way, substantially all of the light 7 emitted from the first light source 5 can be reflected to the first exit surface 3 by reflection at the first reflector 8, in particular by multiple reflections at different reflective surfaces 8a, 8b, 8c of the first reflector 8.

It is possible for the first exit surface 3, in particular the inside of the first exit surface 3 facing the housing 1, to have a structure not shown. This structuring can contribute to the homogenization of the light 7 emitted by the first light source 5. The structuring can be created, for example, by exposing the first exit surface 3 to laser light.

In the embodiments shown, the housing 1 has a section 9 extending downwards from the underside of the cover panel 2. When the lighting device is installed, the section 9 extends obliquely downwards and backwards and forms an angle with the first exit surface 3, which can be between 30° and 80°, preferably between 40° and 70°, for example around 60°.

The lighting device also comprises a reflection device 10, which in the embodiment example shown in FIG. 1 is attached to the outside of the downwardly extending section 9 of the housing 1. For example, the reflection device 10 can be attached to the housing 1 by gluing or screwing. Other connections are also possible.

The reflection device 10 may alternatively or additionally be attached to a section of the cover 2.

The section of the light 7 exiting through the first exit surface 3 strikes the reflection device 10 at least partially and is reflected by it at least partially in such a way that it moves away from the rear end of the motor vehicle rearward. The reflection device 10 is designed in such a way that the light 7 is reflected at least slightly diffusely rearward. For this purpose, the reflection device 10 has a diffusing structure 11.

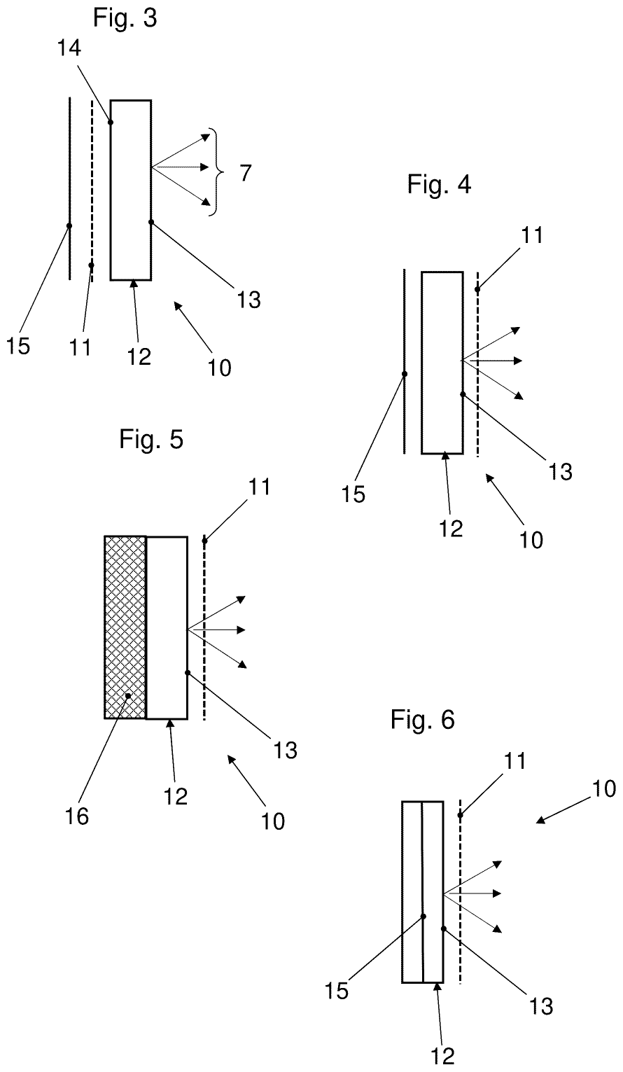

FIGS. 3 to 6 show different embodiments of the reflection device 10. All of the embodiments have a transparent component 12 into which the light 7 can at least partially penetrate. When installed, the component 12 has a rear entry surface 13 for the light 7.

In the first embodiment shown in FIG. 3, the diffusing structure 11 is arranged on an exit surface 14 of the transparent component 12 opposite the entry surface 13. The diffusing structure 11 can be produced in particular by the transparent component 12 being made of plastic and manufactured by injection molding in an injection mold in which the mold surface producing the exit surface 14 is structured. Other methods for creating a structure on the exit surface 14, such as subsequent structuring of a smooth surface after injection molding, are certainly possible.

A reflective layer 15 is applied to the diffusing structure 11 of the exit surface 14. The layer 15 can be a coating in particular. The layer 15 can have a reflectivity that is significantly below 100%, in particular a reflectivity between 20% and 80%, for example around 50%.

In the second embodiment of the reflection device 10 shown in FIG. 4, the diffusing structure 11 is not arranged on the exit surface 14, but on the entry surface 13. In this embodiment, the diffusing structure 11 can also be produced during injection molding in an injection mold or by subsequent structuring.

In the third embodiment of the reflection device 10 shown in FIG. 5, the diffusing structure 11 is also arranged on the entry surface 13. In contrast to the second embodiment, no reflective layer is applied to the exit surface 14. Rather, in the third embodiment, an opaque component 16 is in contact with the exit surface 14, from which the light 7 is at least partially reflected back.

In the fourth embodiment of the reflection device 10 shown in FIG. 6, the diffusing structure 11 is also arranged on the entry surface 13. In contrast to the second embodiment, the reflective layer 15 is not applied to the exit surface 14, but is arranged in the transparent component 12, in particular approximately in the center.

The lighting device also comprises two second light sources 17, which have one, preferably several, light-emitting diodes (LEDs) arranged on a printed circuit board 18 (see FIG. 2). In each case, one of the second light sources 17 is arranged in an outer area of the lighting device with respect to the transverse direction of the motor vehicle. The light-emitting diodes of the second light sources 17 can be arranged next to each other, particularly in the transverse direction of the motor vehicle. The printed circuit board 18 is arranged horizontally in the housing 1 so that the light 19 emitted by the second light sources 17 spreads downwards within the housing 1 in FIG. 2 or, when installed, from the second light sources 17.

The light-emitting diodes of the second light sources 17 can also have different colors in order to implement different functions such as a tail light, a brake light, a position light, a reversing light, a daytime running light or a direction indicator. In the embodiment example shown, the light 19 emitted by the second light sources 17 is used to generate a brake light.

The lighting device further comprises two second reflectors 20, which are arranged in the housing 1 in such a way that the light 19 emitted by the second light sources 17 is in each case at least partially reflected rearward by one of the second reflectors 20 in the direction of the respective second exit surface 4 and exits through this at least partially to the rear out of the housing 1 (see FIG. 2). In particular, the second reflectors 20 can be partially or sectionally concavely curved.

A lens 21 is arranged between each of the second reflectors 20 and the second exit surfaces 4, which can be milky or frosted in particular.

It is also possible for the second exit surfaces 4, in particular the insides of the second exit surfaces 4 facing the housing 1, to have a structuring that is not shown. This structuring can contribute to the homogenization of the light 19 emitted by the second light source 17.

### LIST OF REFERENCE SIGNS

1 housing
2 cover panel
3 first exit surface
4 second exit surface
5 first light source
6 printed circuit board of the first light source
7 light emitting from the first light source
8 first reflector
8a, 8b, 8c reflective surface of the first reflector
9 section of the housing extending downwards
10 reflection device
11 diffusing structure of the reflection device
12 transparent component of the reflection device
13 entry surface of the transparent component
14 exit surface of the transparent component
15 reflective layer of the reflection device
16 opaque component of the reflection device
17 second light source
18 printed circuit board of the second light source
19 light emitting from the second light source
20 second reflector
21 lens between the second reflector and the second exit surface

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for the rear of a motor vehicle, comprising:
a first light source and a second light source;
a housing on or in which the first light source and the second light source are arranged, the housing having a first exit surface for light emitted by the first light source and a second exit surface for light emitted by the second light source;
wherein, in an installed state of the lighting device, the light emitted by the first light source emerges at least partially downward from the housing through the first exit surface, and the light emitted by the second light source emerges at least partially rearward from the housing through the second exit surface;
further comprising a reflection device outside of the housing, such that the light emitted downward from the housing through the first exit surface strikes the reflection device and is at least partially reflected by the reflection device and propagates away from motor vehicle.

2. The lighting device of claim 1, wherein the light emitted by the first light source generates a taillight and the light emitted by the second light source generates a brake light.

3. The lighting device of claim 1, wherein the reflection device has a diffusing structure.

4. The lighting device of claim 1, wherein the reflection device has a transparent component which has an entry surface for light emitted through a cover panel.

5. The lighting device of claim 4, wherein a diffusing structure is arranged on an entry surface of the transparent component or on an exit surface of the transparent component.

6. The lighting device of claim 4, wherein the reflection device has a reflective layer or an opaque layer which at least partially reflects incident light.

7. The lighting device of claim 6, wherein the reflective layer or the opaque layer is arranged on the exit surface of the transparent component.

8. The lighting device of claim 6, wherein the diffusing structure is arranged on the exit surface of the transparent component opposite of the entry surface, and wherein the opaque layer is arranged on the side of the diffusing structure facing away from the exit surface.

9. The lighting device of claim 6, wherein the reflective layer is arranged on the transparent component.

10. The lighting device of claim 1, further comprising a first reflector in the housing, wherein the light emitted by the first light source is at least partially reflected by the first reflector onto the first exit surface.

11. The lighting device of claim 10, further comprising a second reflector in the housing, wherein the light emitted by the second light source is at least partially reflected by the second reflector onto the second exit surface.

12. The lighting device of claim 1, wherein:
the second light source comprises two second light sources;
the second exit surface comprises two second exit surfaces, the two second exit surfaces being disposed in a lateral edge section of the rear of the motor vehicle.

13. The lighting device of claim 1, wherein the reflection device extends over the entire width of the motor vehicle.

14. The lighting device of claim 1, further comprising a cover panel which covers the housing, the first exit surface and the second exit surface being formed in the cover panel.

15. The lighting device of claim 1, wherein the reflection device is disposed on the outside of the housing such that, in the installed state, the reflection device extends downwards below the first exit surface and forms an angle of between 30° and 80° with the first exit surface.
